(19) United States
(12) Patent Application Publication
(10) Pub. No.: US 2004/0030561 A1
(43) Pub. Date: Feb. 12, 2004

(54) Method and apparatus for digital signal communication between computer-based multi-channel audio controller and surround sound systems

(76) Inventor: Heng-Chien Chen, Taipei (TW)

Correspondence Address: Rabin & Berdo, P.C., Suite 500, 1101 14th Street, Washington, DC, 20005, US

(21) Appl. No.: 10/214,732

(22) Filed: Aug. 9, 2002

(51) Int. Cl. G10L 21/00

(52) U.S. Cl. 704/500

(57) ABSTRACT

A method and apparatus for digital signal communication between a computer-based multi-channel audio controller and a surround sound system is disclosed. The method involves converting analog audio signals on multiple audio channels output of the computer multimedia audio device to digital voice packets, passing to the broadcasting end over a signal transmission medium, and restoring the received digital voice packets back to the original analog audio signals. The signal transmission medium is connected to multiple speakers, such that each speaker only retrieves those packets belonging to the same audio channel and restores them to the analog audio signals. The restored analog audio signals are then output over the speaker after power amplification. Such signal transmission means avoidance of the usual high RLC on the conventional audio cables causing power attenuation and degradation of sound reproduction.

### BACKGROUND OF THE INVENTION

1. Field of the Invention

The present invention relates to a method and apparatus for digital signal communication between computer-based multi-channel audio controller and surround sound systems, especially to a method of transmitting audio signals from a multi-channel audio controller through a signal transmission medium to multiple surround sound speakers connected on line, so as to simplify the setup procedures for audio equipment and avoid possible degradation of sound due to power attenuation in the conventional audio cables.

2. Description of Related Arts

Nowadays, most desktop computers are equipped with either a compact disc (CD) player or a digital versatile disc (DVD) player for playing out pre-recorded movies, musical numbers, or computer games. Although the storage technology and playback mechanism used in a typical DVD player closely resembles a conventional CD player, the information storage capacity of the DVD is much higher than the CD. Therefore it is not surprising to find the quality of sound and video output from the DVDs much better than the conventional CDs. Generally a multimedia computer is only equipped with a multimedia audio device that can support a right channel and a left channel speakers, incapable of producing the high quality stereo and surround sound effects as in theaters or stage performances. To enhance the sound effects, the multi-channel audio controller has to be modified and at least five speakers are needed for a surround sound system.

For audio fans equipped with multiple speakers, their surround sound speakers still have to be connected to the multimedia computers through multiple high-powered audio cables (70) as shown in FIG. 6. For example, the set up of a five-speaker system (60) requires at least five segments of the conventional audio cable to connect all system components. Furthermore, the speakers have to be kept a certain distance away from the audio player for the best sound effects. The extended cable length for remote speakers is another problem that would probably cause power attenuation and degradation in sound reproduction.

### SUMMARY OF THE INVENTION

The main object of the present invention is to provide a method and apparatus for digital signal communication from a computer-based audio device to a surround sound system through a regular computer networking cable interconnecting various components of the surround sound system. With the present invention, the wiring for surround sound speakers can be considerably simplified and the sound quality can be enhanced.

The method for digital signal communication between a computer-based multi-channel audio controller and a surround sound system comprises the steps of converting the analog audio signals over multiple audio channel outputs of the computer audio device to digital voice packets after coding and data compression, passing the voice packets to the broadcasting end over a bus-type signal transmission medium, and restoring the packet content back to the original audio signals at the broadcasting end, and then amplifying and reproducing the original sound over the speakers. The bus-type signal transmission medium is connected to all the speakers in tandem arrangement, so that each speaker can only retrieve those voice packets belonging to the same audio channel. It should be noted that the original sound quality is retained after the signal conversion, transmission and amplification processes.

The secondary objective of the invention is to provide a digital communication device capable of simplifying the setup for surround sound systems, which comprises a digital signal transmission device connected to a multi-channel audio controller, at least one set of digital signal reception devices connected with a corresponding power amplifier, and a bus-type signal transmission medium connected between the digital signal transmission device and various digital signal reception devices.

The present invention is to be applied on the multimedia audio device or controller chip, which connects the multimedia computer having a CD or DVD player to a surround sound speaker system, capable of replacing the conventional audio cables and cutting down the wiring costs considerably.

In actual operation, the outputs of continuous analog signals over multiple audio channels are converted by the above mentioned digital signal transmission device to digital voice packets with respect to each audio channel. The digital voice packets are transmitted over the signal transmission medium to the broadcasting end, where each speaker retrieves the packets identified by the respective audio channel. The packet contents are restored to the original analog audio signals after decoding and data compression. Decoded analog audio signals are passed through the power amplifier to be output over the speaker. According to the present invention, the proposed scheme of digital signal transmission over the networking cables enables consumers to cut down the cable connecting costs substantially, and may eliminate the problem of power attenuation in the conventional audio cables.

The features and structure of the present invention will be more clearly understood when taken in conjunction with the accompanying figures.

### BRIEF DESCRIPTION OF THE DRAWINGS

FIG. 1 is the block architecture of the present invention;

FIG. 2 is block diagram of the first part of the implementation hardware for the invention;

FIG. 3 is block diagram of the second part of the implementation hardware for the first embodiment of the invention;

FIG. 4 is a block diagram of the second part of the implementation hardware for the second embodiment of the invention;

FIG. 5 is a proposed setup for the multimedia computer and the surround sound system;

FIG. 6 is the conventional setup for a multimedia computer and the speaker system.

### DETAILED DESCRIPTION OF THE PREFERRED EMBODIMENT

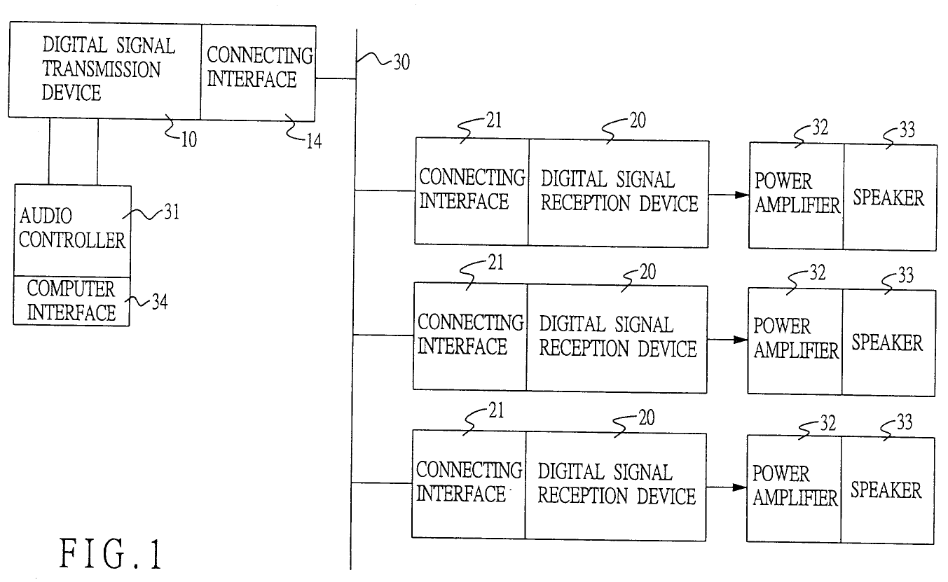

With reference to FIG. 1, the method for digital signal communication between the computer-based multimedia audio device and multiple speakers and amplifiers comprises the steps of:

converting original analog audio signals over multiple audio channels output of a multimedia audio device installed on a computer to digital format;

coding digital signals according to the corresponding audio channel and generating voice packets before sending to a remote broadcasting device over a signal transmission medium;

decoding the digital voice packets by the broadcasting device after receiving the packets respective to the audio channel; and

restoring the audio signals to the original analog to be broadcast over a speaker after power amplification.

Data compression and decompression can be optionally included in the above coding and decoding processes respectively to solve the problem of transmission bandwidth on certain signal transmission media.

With reference to FIG. 1, the architecture of the apparatus in accordance with the present invention comprises:

a digital signal transmission device (10) being connected to multiple channel outputs of a multimedia audio device (31), e.g. FR, FL, RR, RL (the current embodiment is equipped with MIDI, MIC and joystick output ports).

at least one digital signal reception device (20) being connected to a corresponding power amplifier (32) which in turn is connected to a corresponding speaker (33); and

a signal transmission medium (30) being a bus-type signal transmission medium connected to the respective connecting interface (14) interconnecting the digital signal transmission device (10) and the digital signal reception device (20).

In actual operation, the analog audio signals over multiple audio channels output of the multimedia audio device (31) are converted by the digital signal transmission device (10) to the digital voice packets and passed to the signal transmission medium (30), and at the broadcasting end, the voice packets are retrieved by a digital signal reception device (20) respective to the same audio channel, and then the decoded audio signals are passed through the power amplifier (32) to be output over a respective speaker (33).

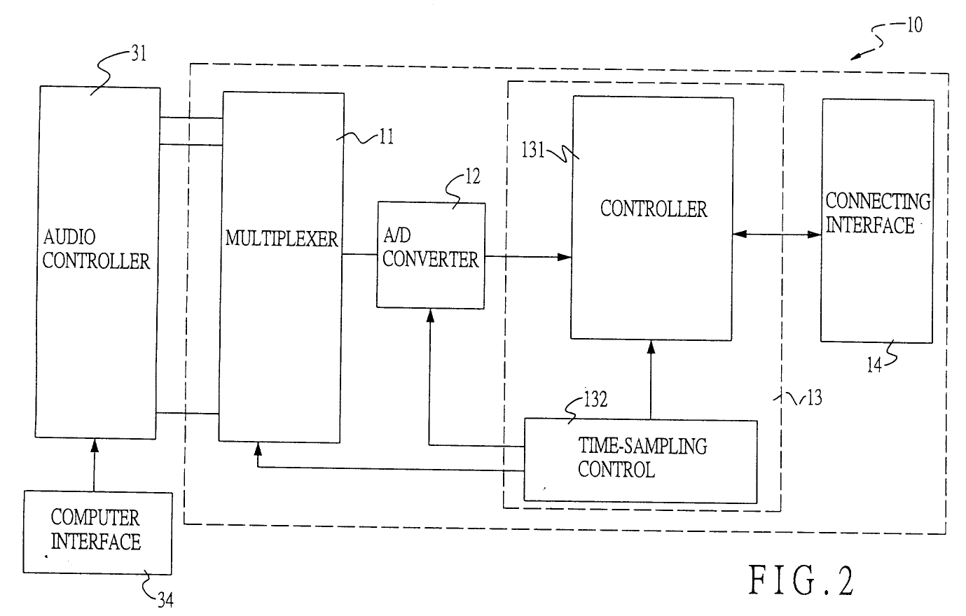

With reference to FIG. 2, the digital signal transmission device (10) comprises a multiplexer (11), an A/D converter (12), a front-end control unit (13), and a connecting interface (14).

The multiplexer (11) has multiple input terminals connected to corresponding channel outputs of the multimedia audio device (not identified in the diagram) and the time-sampling control (132), whose output terminal is connected to the front-end control unit (13) through the A/D converter (12) for passing the digital signals to the front-end control unit (13).

The front-end control unit (13) is responsible for converting the audio signals to voice packets possibly including a data compression mechanism, comprises:

a controller (131) which may be a CPU with arithmetic processing capabilities,

a time-sampling control (132) being connected between the controller (131), a AID converter (12) and a multiplexer (11) for providing the necessary clock pulse to synchronize the operation components.

The A/D converter (12) is to convert analog audio signals to digital format.

The connecting interface (14) being coupled onto the output terminal of the front-end control unit (13) is to be connected with a bus-type signal transmission medium (not identified in the diagram), and also being connected to the time-sampling control (132) for receiving the same clock pulse as the front-end control unit (13).

In actual operation, continuous audio signals are sampled from multiple audio channels of the digital signal transmission device (10) through the multiplexer (11); and the analog audio signals are passed to the A/D converter (12) converting to the digital signal format; and the digital signals are then passed to the controller (131) for coding and data compression to become voice packets; and the voice packets are passed onto the signal transmission medium (not identified in the diagram) through the connecting interface (14).

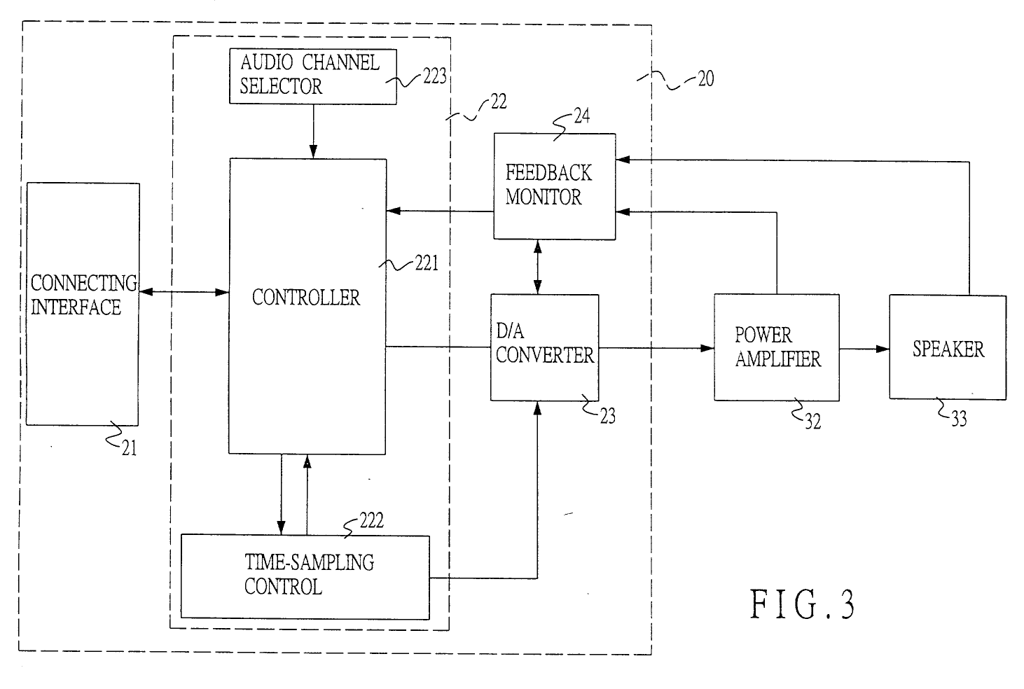

With reference to FIG. 3, the block diagram shows the digital signal reception device (20) comprises a rear-end control unit (22), a D/A converter (23), a feedback monitor (24), and a connecting interface (21).

The rear-end control unit (22) is to convert the audio signals back from the voice packets received, which may possibly include a data decompression mechanism, comprising:

a controller (221) which may be a microprocessor with arithmetic processing capabilities and whose output terminal being connected to a D/A converter (23) through a time-sampling control (222); and

an audio channel selector (223) being connected to the input terminal of the controller (221) for setting up the audio channel for the controller (221), may be implemented by a press key, rotation control knob or DIP switch for manually controlling the audio channel reception.

The feedback monitor (24) being installed in between the input terminal of the controller (221) and the output of the power amplifier (32) and the speaker (33) is used to return the output of a power amplifier (32) back to the controller (221).

The D/A converter (23) being installed on the output terminal of the rear-end control unit (22) connected to the time-sampling control (222) is used for decoding and decompressing the digital signals received and restoring them to the analog audio signals to be output over a speaker (33) through a power amplifier (32).

The connecting interface (21) being attached to the output terminal of the rearend control unit (22) is to be connected to the bus-type signal transmission medium (not shown in the diagram).

In actual operation, digital voice packets on the specific audio channel are set up by the rear-end control unit (22) through the audio channel selector (223), allowing the control unit (22) of the audio signal reception device (20) to retrieve the corresponding voice packets on the same audio channel from the signal transmission medium through the connecting interface (21). The voice packets are then decoded and decompressed to produce the analog audio signals, and passed to the power amplifier (23) for amplification and the speaker (33) for sound reproduction.

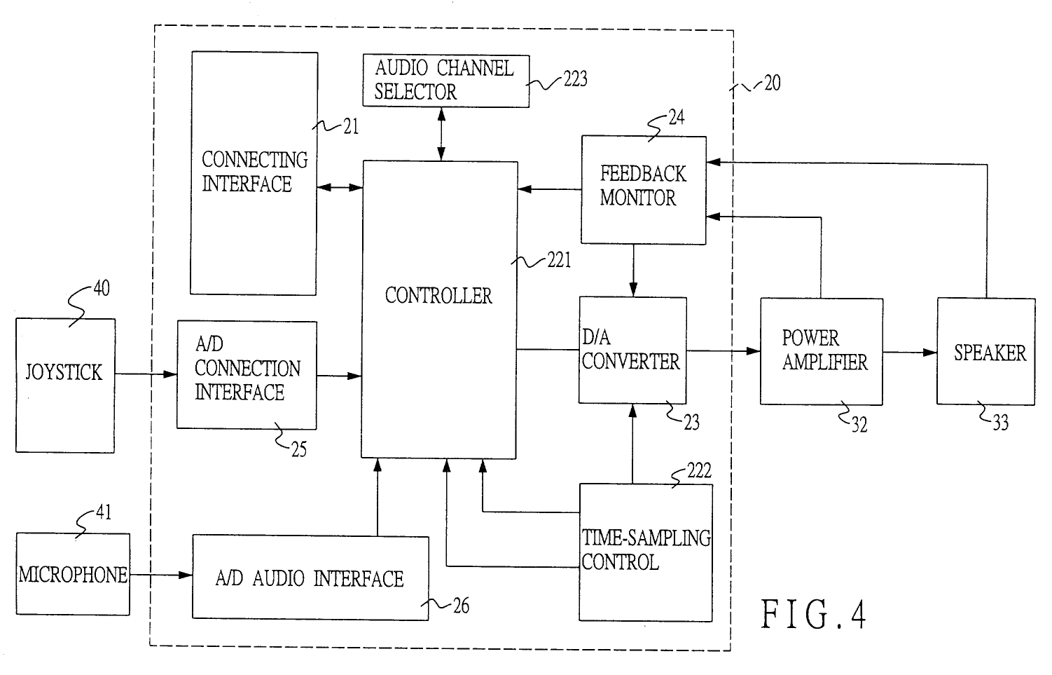

The multimedia audio device in accordance with the current embodiment is connected to a joystick (40), whose signals are transmitted through the multimedia audio device to the computer. With reference to FIG. 4, the A/D converter (25) of the digital signal reception device (20) also may have a J-Port for connecting to a joystick (40). An interface connector may also appear on an A/D connection converter (25) or an A/D audio converter (26) for connecting to a microphone (41), where the A/D audio converter (26) being coupled onto the input of the controller (221) transmits the signals of the joystick (40) and the microphone (41) to the multimedia audio device through the connecting interface (21).

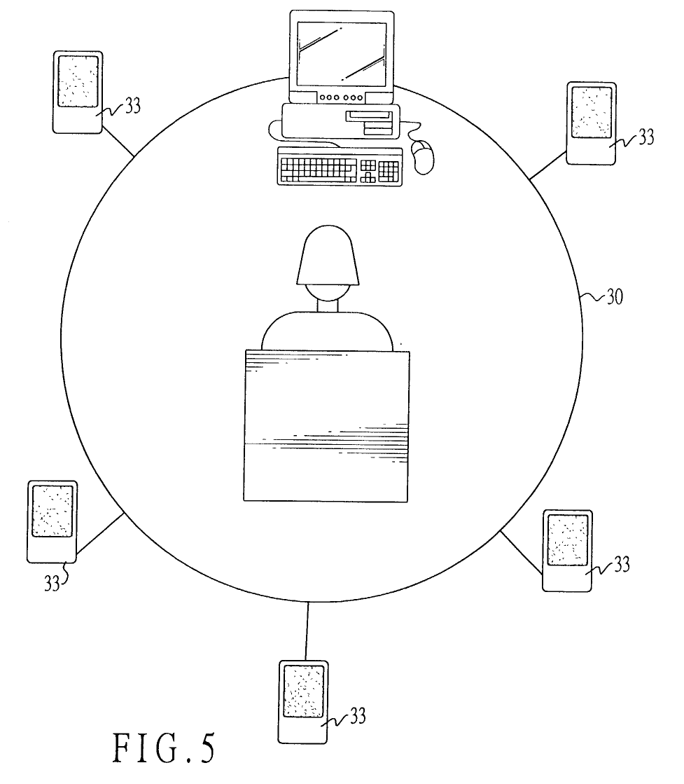

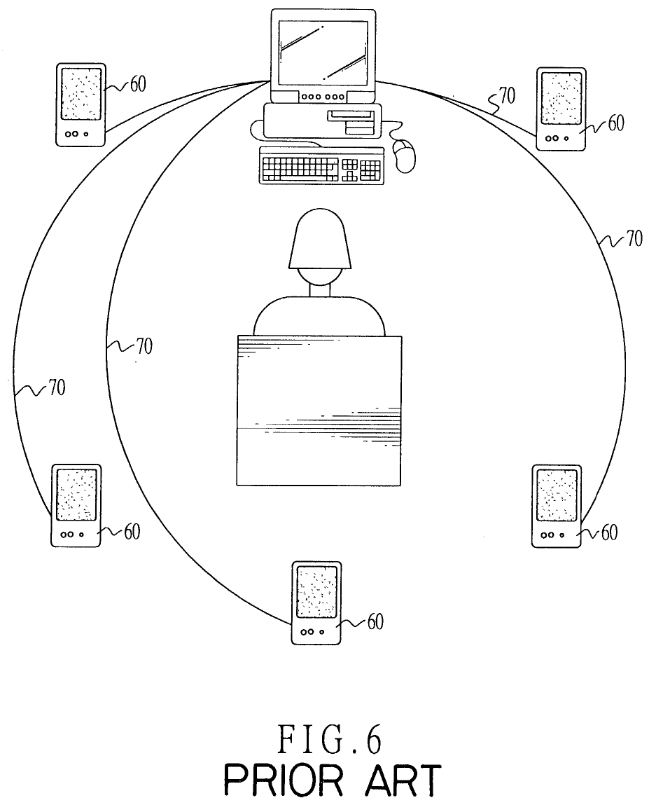

FIG. 5 is a proposed set up for the multimedia computer and the surround sound system, in which the respective speakers (33) having the power amplifiers (32) and digital signal reception devices (20) are placed in locations surrounding the multimedia computer, and linked to the multi-channel audio controller installed in the computer through the signal transmission medium (30). The use of the signal transmission medium in accordance with the present invention can replace the conventional high-powered audio signal transmission medium completely, as compared with the conventional equipment setup shown in FIG. 6. In the conventional scheme, speakers are connected to their respective amplifier by an independent high-powered audio signal transmission medium; thus multiple segments of audio signal transmission media are needed for the surround sound system setup. But in the present invention, one signal transmission medium interconnects all the digital signal reception devices (20) in tandem arrangement, which is advantageous in many ways:

Reliable signal transmission: using a single networking cable over which digitized voice packets are transmitted;

Light-weighted audio equipment and simplified setup procedures: replacing the complicated wiring and cable connections;

High quality sound reproduction: avoiding the degradation of sound reproduction due to power attenuation; and

Low cost: using networking cable and fewer cables to replace the expensive conventional audio cables; and

High compatibility: supporting all peripherals such as joysticks and microphones.

The foregoing description of the preferred embodiments of the present invention is intended to be illustrative only and, under no circumstances, should the scope of the present invention be so restricted.

What is claimed is:

1. A method for digital signal communication between a computer-based multi-channel audio controller and a surround sound system comprises the steps of:
converting analog audio signals over multiple channels output of a multimedia audio device to digital voice packets;
sending digital voice packets to a remote broadcasting device through a signal transmission medium;
retrieving digital voice packets respective to an audio channel from a bus-type signal transmission medium; and
restoring audio signals to the original analog format to be output over a broadcasting device after power amplification.

2. The method for digital signal communication between a computer-based multi-channel audio controller and a surround sound system as claimed in claim 1, wherein the process of converting analog audio signals to digital voice packets include the steps of:
conversion of analog audio signals to digital format to be transmitted over a signal transmission medium; and
coding of digital voice packets respective to an audio channel.

3. The method for digital signal communication between a computer-based multi-channel audio controller and a surround sound system as claimed in claim 2, wherein the digital signal processing including the steps of:
decoding of digital voice packets after retrieving corresponding voice packets from a signal transmission medium respective to an audio channel; and
converting decoded digital signals to the original analog format respective to an audio channel.

4. The method for digital signal communication between computer-based multi-channel audio controller and surround sound systems as claimed in claim 3, wherein the process of coding digital signal packets further includes a data compression mechanism, thus the digital signal packets have to be decompressed in decoding to be restored to the original analog audio signals.

5. The method for digital signal communication between a computer-based multi-channel audio controller and a surround sound system as claimed in claim 1, wherein the signal transmission medium is a bus-type networking cable.

6. The method for digital signal communication between a computer-based multi-channel audio controller and a surround sound system as claimed in claim 2, wherein the signal transmission medium is a bus-type networking cable.

7. The method for digital signal communication between a computer-based multi-channel audio controller and a surround sound system as claimed in claim 3, wherein the signal transmission medium is a bus-type networking cable.

8. The method for digital signal communication between a computer-based multi-channel audio controller and a surround sound system as claimed in claim 4, wherein the signal transmission medium is a bus-type networking cable.

9. An apparatus for digital signal communication between a computer-based multi-channel audio controller and a surround sound system, comprising:
a digital signal transmission device being connected to multiple channels outputs of a multimedia audio device;
at least one digital signal reception device being connected to a corresponding power amplifier and in turn to a speaker; and
a bus-type signal transmission medium for connecting the digital signal transmission device and all digital signal reception devices.

10. The apparatus for digital signal communication between a computer-based multi-channel audio controller and a surround sound systems as claimed in claim 9, wherein the digital signal transmission device includes:
a front-end control unit for processing digital voice packets, in which data compression mechanism may be included;
a multiplexer having multiple input terminals connected to a corresponding audio channel output of the multimedia audio device, and the output terminal of which being connected to a front-end control unit for passing on the digital signals; and
a connecting interface being coupled onto an output terminal of the front-end control unit for connecting to the bus-type signal transmission medium.

11. The apparatus for digital signal communication between a computer-based multi-channel audio controller and a surround sound system as claimed in claim 10, wherein the front-end control unit of the digital signal transmission device further includes:
a controller having an input connected to an output of an A/D converter may be a microprocessor with arithmetic computing capabilities;
a feedback monitor being installed in between the input of the control unit and the output of a power amplifier and a speaker for returning the amplified signal back to the front-end control unit;
an A/D converter being installed between the multiplexer and the controller;
a multiplexer having multiple input terminals connected to corresponding channel outputs of the multimedia audio device and the time-sampling control, and whose output terminal being connected to the front-end control unit through the A/D converter for passing on the digital signals; and
a time-sampling control being connected between the controller, the A/D converter, and the multiplexer for providing the necessary clock pulse to synchronize the operation.

12. The apparatus for digital signal communication between a computer-based multi-channel audio controller and a surround sound system as claimed in claim 10, wherein the digital signal reception device comprises:
a rear-end control unit for processing voice packets, in which data decompression mechanism may be included;
a D/A converter being installed on the output of the control unit for decoding and data decompression of the digital voice packets before passing on to the power amplifier;
a connecting interface being coupled to the input of the control unit for connecting to the bus-type signal transmission medium;
a bus-type signal transmission medium being connected between the digital signal transmission device installed in the multimedia computer and the digital signal reception devices installed in the speakers may be a BDS networking cable.

13. The apparatus for digital signal communication between a computer-based multi-channel audio controller and a surround sound system as claimed in claim 12, wherein the rear-end control unit of the digital signal reception device comprises:
a controller whose output being connected to the D/A converter through a time-sampling monitor; and
a time-sampling control being connected in between a controller, the D/A converter and a multiplexer for providing the clock signal to synchronize the operation.

14. The apparatus for digital signal communication between a computer-based multi-channel audio controller and a surround sound system as claimed in claim 13, wherein the rear-end control unit of the digital signal reception device comprises:
a controller whose output being connected to a D/A converter through a time-sampling control may be a microprocessor with arithmetic computing capabilities;
an audio channel selector being installed on the input of the controller for setting up the audio channel for reception by the controller; and
a time-sampling control being connected between the controller, D/A converter and the multiplexer for providing the clock pulse to synchronize the operation.

15. The apparatus for digital signal communication between a computer-based multi-channel audio controller and a surround sound system as claimed in claim 12, wherein the digital signal reception device further includes an interface on the A/D converter for connecting with a microphone.

16. The apparatus for digital signal communication between a computer-based multi-channel audio controller and a surround sound system as claimed in claim 12, wherein the digital signal reception device further includes an interface on the A/D converter for connecting to a joystick.

17. The apparatus for digital signal communication between a computer-based multi-channel audio controller and a surround sound system as claimed in claim 15, wherein the digital signal reception device further includes an interface on the A/D converter for connecting to a joystick.

18. The apparatus for digital signal communication between a computer-based multi-channel audio controller and a surround sound system as claimed in claim 9, wherein the signal transmission medium is a bus-type networking cable.

19. The apparatus for digital signal communication between a computer-based multi-channel audio controller and a surround sound system as claimed in claim 14, wherein the audio channel selector may be any one of a press key, rotation knob, or DIP switch control.
